(19) United States
(12) Patent Application Publication
(10) Pub. No.: US 2021/0041175 A1
(43) Pub. Date: Feb. 11, 2021

(54) WATERLESS SYSTEM AND METHOD FOR COOLING A METALLURGICAL PROCESSING FURNACE

(71) Applicant: Berry Metal Company, Harmony, PA (US)

(72) Inventor: Edward J. Green, Sewickley, PA (US)

(21) Appl. No.: 16/978,846

(22) PCT Filed: Mar. 8, 2019
(86) PCT No.: PCT/US19/21373

§ 371 Date: Sep. 8, 2020

Related U.S. Application Data
(60) Provisional application No. 62/640,449, filed on Mar. 8, 2018.

(51) Int. Cl. F27D 9/00; C21B 7/10; F25B 9/00; F01D 15/10

(52) U.S. Cl. CPC F27D 9/00; C21B 7/10; F25B 9/008; F27B 3/24; F27D 2009/0005; F27D 2009/0048; F01D 15/10

(57) ABSTRACT

The present invention relates to a waterless system and method for cooling a metallurgical processing furnace. Supercritical carbon dioxide (sCO₂) is used as a coolant, as opposed to water, which provides several advantages. For example, sCO₂ can be used at higher temperatures, the risk of an explosion (with use of water) is eliminated, there are no problems with regard to reverse solubility of water at higher temperatures that can foul passageways, and smaller cooling passages can be used thus reducing the cost of cooling panels. A system is disclosed which uses a reservoir to store the sCO₂, a compressor or pump to cause the delivery of the sCO₂ to cooling passages in the furnace, a pressure reducing valve or a turbine to decrease the pressure of the sCO₂, and a heat exchanger to cool the sCO₂ to a liquid state as the sCO₂ travels back to the reservoir.

This application claims priority to U.S. Provisional Patent Application No. 62/640,449, filed in the United States Patent and Trademark Office on Mar. 8, 2018.

### FIELD OF THE INVENTION

The present invention generally relates to systems and methods for cooling a metallurgical processing furnace. More specifically, the present invention relates to a system and method for cooling a metallurgical processing furnace using supercritical carbon dioxide (“sCO₂”).

### BACKGROUND OF THE INVENTION

In the steel industry, furnaces are used to process the steel. These furnaces are typically formed of panels. The panels tend to experience substantial mechanical, chemical, and thermal stresses during the operation of the furnace, which can damage the integrity of the panels over time.

For example, the panels are impacted mechanically during loading of the furnace (i.e., when scrap metal is loaded into the furnace for subsequent processing by the furnace). Furthermore, the furnace operates at extremely high temperatures in order to cause certain chemical reactions to take place inside the furnace. As such, in addition to being mechanically impacted, the panels experience both chemical and thermal stresses when the furnace is used to process the metal inside.

Not only do the panels experience mechanical, chemical, and thermal stresses, but these stresses are cyclical given that the furnace is used intermittently. Even if a furnace is used very often, each instance of using the furnace involves the panels being subjected to substantially fluctuating and extreme temperatures.

The stresses mentioned above can, over time, damage the structural integrity of the panels, leading to erosion as well as the formation of cracks or fissures, thereby reducing the life of the panels. Periodically, the panels need to be repaired or even replaced.

To combat the extreme temperatures to which the panels of a furnace are subjected, a common practice in the industry is to use water to cool the panels. Specifically, water-cooled panels are mounted against the panels of the furnace, and the water-cooled panels act as a heat sink taking heat away from the panels of the furnace.

It is extremely important not to continue using a furnace that needs one or more panels repaired or replaced. For example, if a given panel of a furnace has cracks or fissures, and the furnace is used, these cracks or fissures can cause water from a water-cooled panel to leak into the furnace. This can result in operating conditions that are very dangerous. Specifically, if the water which leaks into the furnace enters the liquid metal bath in the furnace, or infiltrates into the refractory coating which is on the inside wall of the furnace, an immediate evaporation and sudden volume expansion of the water may occur, which can result in an explosion. The bottom line is that water leaking into an operating furnace can not only result in the furnace becoming further damaged, but more importantly it can even result in an explosion which jeopardizes the safety of workers and their surrounding environment.

Because cracks and fissures in the furnace panels can be so dangerous, workers are tasked with visually inspecting the integrity of the panels of the furnace after each time the furnace is used. Additionally, when a furnace is being used to process metal, oftentimes systems are used during the process to try to detect if there is water leaking into the furnace. For example, some systems analyze the steam and hydrogen content of the exhaust gases of a furnace to try to determine whether an internal leak exists. Still other systems monitor the flow rate, pressure and/or temperature of the water that is flowing through the water-cooled panels to make such a determination. One such system is disclosed in United States Patent Publication No. 2009/0148800, for example.

Regardless of when a defect in a panel is detected, and whether the defect was detected via a visual inspection between processes, or during a given process, once it is determined that a panel is damaged, that panel must be either repaired or replaced. This results in added expenses and downtime for the furnace. Sometimes, a defect is detected during a critical time in the process and the process cannot be stopped. As a result, if the panel could have been repaired, sometimes having to continue with the operation of the furnace causes the panel to become damaged beyond repair (i.e., a complete replacement of the panel becomes necessary).

As discussed above, the panels of a metallurgical processing furnace are subjected to great stresses when the furnace is used during metal processing. The stresses cause the panels to have to be periodically repaired or replaced, which results in substantial economic loss.

Using water-cooled panels to try to counter the high temperatures experienced during the process can result in extending the life of the panels. However, if fissures or cracks form in a given panel and water leaks therethrough, further damage to the furnace can result and there could even be a catastrophic explosion.

Moreover, when water is used to cool the panels, the water must be treated prior to use in order to prevent fouling of the cooling passages from mechanical or chemical deposition of particles that would otherwise be entrained in the water. Treatment of the water is also required to prevent bacterial growth that can cause damage to the passageways or cause airborne disease. This treatment is an economic burden to the metallurgical process.

Modern furnaces currently limit cooling water temperatures to approximately 122 degrees Fahrenheit. Above this temperature, the minerals previously dissolved in the water become less soluble causing fouling of the cooling passages to occur at a much higher rate. Because the water temperature is kept so low, the water-cooled panels pull more heat from the panels of the furnace than if the water flowing through the passages were allowed to be at a temperature higher than 122 degrees Fahrenheit.

### SUMMARY OF THE INVENTION

An objective of a preferred embodiment of the present invention is to provide a waterless system and method for cooling a metallurgical processing furnace.

Another objective of a preferred embodiment of the present invention is to provide a system and method for cooling a metallurgical processing furnace that is safer, less expensive in terms of maintenance and downtime, as compared to water-based cooling systems.

Yet another objective of a preferred embodiment of the present invention is to provide a system and method for cooling a metallurgical processing furnace, where no immediate and high volumetric expansion results in case of leakage of the coolant into the furnace, such as through a crack or fissure.

Still another objective of a preferred embodiment of the present invention is to provide a system and method for cooling a metallurgical processing furnace that uses a coolant that avoids the risk of explosions.

Briefly, a specific, preferred embodiment of the present invention provides a waterless system and method for cooling a metallurgical processing furnace. In stark contrast to water, supercritical carbon dioxide (“sCO2”) is used to cool the panels of the metallurgical processing furnace.

Using sCO₂ as a coolant instead of water provides many advantages. For example, the high cost associated with treating the cooling water is avoided. Additionally, sCO₂ does not contain dissolved minerals like water does, and therefore does not have an issue with inverse solubility fouling out the cooling passages at temperatures higher than 122 degrees Fahrenheit. Still further, sCO₂ can be operated at much higher temperatures than that of water which reduces the heat loss from the furnace to the cooling fluid. Finally, sCO₂ has a lower viscosity than water allowing for the cooling passages through which the sCO₂ flows to be smaller than they could be in a water-based cooling system. The smaller cooling passages enable the thickness of the panels to be reduced, thus reducing the overall cost of the panels.

A preferred embodiment of the present invention comprises:

a waterless system for using sCO₂ to cool a metallurgical processing furnace, the system comprising:

a reservoir configured to store the sCO₂;

at least one of a compressor or a pump connected to the reservoir and configured to pull the sCO₂ from the reservoir and deliver the sCO₂ to cooling passages in one or more panels comprising the metallurgical processing furnace;

at least one of a pressure reducing valve or a turbine connected to the furnace and configured to decrease the pressure of the sCO₂; and

a gas to air heat exchanger connected to the reservoir as well as to the at least one pressure reducing valve or turbine, wherein the gas to air heat exchanger is configured to receive the sCO₂ from the at least one pressure reducing valve or turbine, and wherein the gas to air heat exchanger is configured to cool the sCO₂ such that the sCO₂ is in a liquid state as it leaves the air to gas heat exchanger and travels back to the reservoir.

Another preferred embodiment of the present invention comprises:

using a reservoir to store the sCO₂;

using at least one of a compressor or a pump connected to the reservoir to pull the sCO₂ from the reservoir and deliver the sCO₂ to cooling passages in one or more panels comprising the metallurgical processing furnace;

using at least one of a pressure reducing valve or a turbine connected to the furnace to decrease the pressure of the sCO₂; and

using a gas to air heat exchanger connected to the reservoir as well as to the at least one pressure reducing valve or turbine to receive the sCO₂ from the at least one pressure reducing valve or turbine and to cool the sCO₂ such that the sCO₂ is in a liquid state as the sCO₂ leaves the air to gas heat exchanger and travels back to the reservoir.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a schematic diagram of a system which in in accordance with an embodiment of the present invention; and

FIG. 2 is a block diagram of a method using the system shown in FIG. 1, in accordance with an embodiment of the present invention.

### DETAILED DESCRIPTION OF THE EMBODIMENTS

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

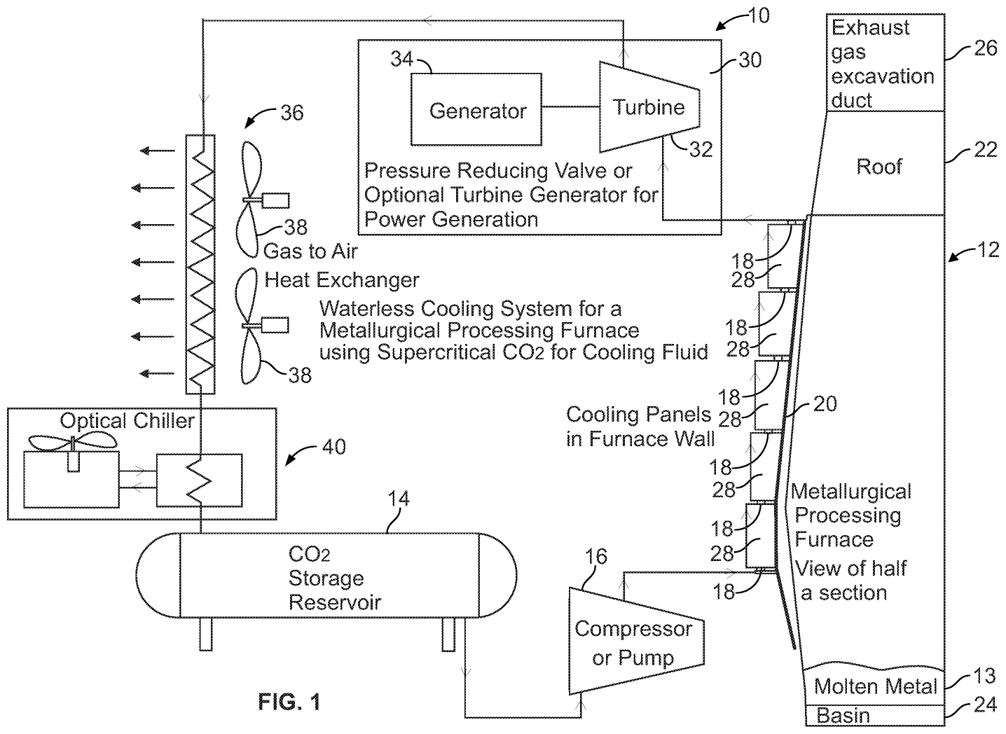

FIG. 1 is a schematic diagram of a system 10 provided in accordance with a preferred embodiment of the present invention. As shown, the system 10 is employed in connection with a metallurgical processing furnace 12, such as an electric-arc furnace (“EAF”), blast furnace, basic oxygen furnace (“BOF”), etc. for the production of steel, iron, nickel, copper, etc. The furnace 12 incorporates cooling panels 28 or some other type of cooling system. In FIG. 1, only half the furnace 12 is shown in section. As shown, the furnace 12 contains a molten metal bath 13.

The system 10 in accordance with an embodiment of the present invention uses supercritical carbon dioxide (“sCO₂”) to cool the furnace 12. The properties of sCO₂ change significantly near the pseudo-critical line, which exists above the critical pressure and critical temperature of the sCO₂. At supercritical pressure, there is no liquid-vapor phase transition so the sCO₂ does not expand suddenly, in high contrast to how water quickly expands to steam. As such, using sCO₂ eliminates the risks of explosion associated with using water as a coolant. Furthermore, the heat capacity of sCO₂ increases significantly near the pseudo-critical line, which gives it beneficial thermal capabilities.

As shown in FIG. 1, the system 10 comprises a reservoir 14 which is configured to store carbon dioxide (“CO₂”). The CO₂ is under high pressure in the reservoir 14, which maintains a large portion of the CO₂ in a liquid state with a smaller portion of gas above in the reservoir 14.

The system 10 also includes a pump or compressor 16 that is configured to pull the CO₂ from the reservoir 14, causing an increase in pressure. The cooling fluid (sCO₂) is then sent into panel cooling passages 18 in walls 20, roof/dome 22, basin 24, exhaust gas evacuation duct 26 and/or an auxiliary apparatus such as burner boxes, injector boxes, and tubular instrumentation panels protruding into the metallurgical processing furnace 12. The schematic shown in FIG. 1 only shows the protruding wall cooling panels 28 for clarity. The passages of these panels 28 can be pipes or tubes in contact with the hot face of the panels 28 (nearest the molten metal), passageways cast into the walls 20, or passages formed by welding or brazing combinations of plate, pipe or tube together to provide the fluid a thermal conduction path to the hot face. These passages are generally serpentine in nature so as to provide complete thermal coverage of the hot face of the panel 28. The panels 28 of the metallurgic furnace 12 are generally limited in size to be smaller than the whole of the walls 20, roof/dome 22, exhaust gas evacuation duct 26, or basin 24 to minimize thermal stress. As multiple panels 28 comprise a section, these panels 28 can be cooled in parallel or series in the cooling circuit by connecting them with hoses, tubes, or piping. Preferably, multiple separate circuits of passageways are built into each panel 28. These separate circuits preferably have individual leak detection units that are tied into automatic shutdown systems that allow a leaking circuit to be closed while still maintaining cooling flow to the remainder of the cooling panel 28.

As discussed previously hereinabove, water-cooled systems must keep the water below a certain temperature so to mitigate the risk of fouling the water passages. In contrast to water, sCO₂ does not contain dissolved minerals and therefore will not cause fouling of the passages. The operating temperature of the sCO₂ can be raised substantially, thereby reducing the differential temperature between the furnace and the cooled wall, which reduces the heat removed from the furnace 12 and results in the saving of energy.

Furthermore, the sCO₂ has a much lower viscosity than water, thereby allowing for a much smaller passage for the same pressure drop. The smaller passage allows the panel to be thinner which reduces the amount of material used to manufacture the panel and therefore the cost of the panel 28.

As shown in FIG. 1, the system 10 preferably includes a pressure reducing mechanism 30 that is configured to reduce the pressure of the sCO₂ as the sCO₂ passes therethrough. Once the sCO₂ is through the furnace 12 portion of the cooling circuit, the sCO₂ passes through the pressure reducing mechanism 30. Preferably, the pressure reducing mechanism 30 is configured to drop the pressure of the sCO₂ slightly above the tank storage pressure of the reservoir 14. This expansion drops the temperature slightly due to the Joule-Thomson effect.

The pressure reducing mechanism 30 can take many forms. For example, a pressure limiting valve can be used, or a turbine 32 can be used. If a turbine 32 is used, preferably the turbine 32 is coupled with a generator 34 which recovers the waste heat energy taken from the metallurgical processing furnace 12 and turns it into electricity for running the turbine 32.

As shown in FIG. 1, preferably the system 10 also includes a gas to air heat exchanger 36. After the sCO₂ fluid passes through the pressure reducing mechanism 30 (such as a pressure reducing valve or expansion turbine), the sCO₂ is further cooled in the air to gas heat exchanger 36 preferably with the use of cooling fans 38. Preferably, the sCO₂ is kept at a high enough pressure that it is in a liquid state as it leaves the air to gas heat exchanger 36.

As shown in FIG. 1, an optional chiller system 40 using a refrigerant cycle can be used for extremely hot ambient temperatures where additional cooling is required to turn the sCO₂ into a liquid state. Regardless of whether a chiller 40 is used, the system 10 is configured such that the sCO₂ fluid recycles back to the reservoir 14 for subsequent use as a coolant in the system 10, as described previously.

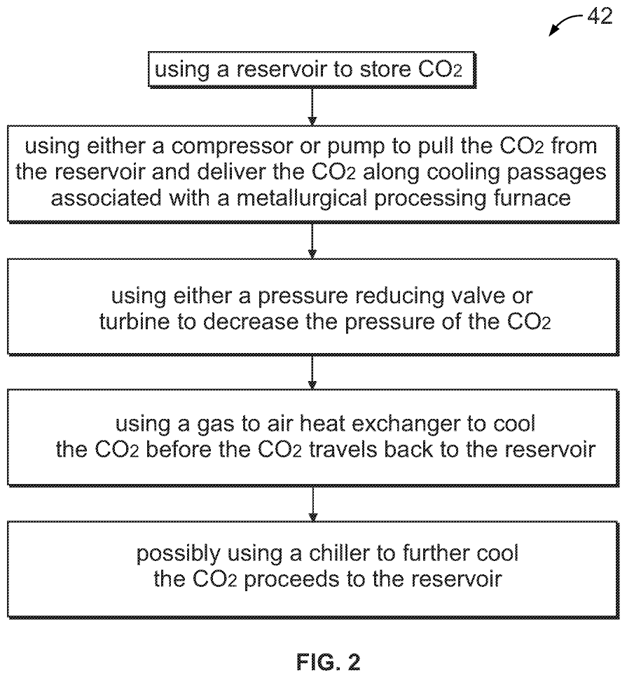

FIG. 2 is a block diagram of a method 42 using the system 10 shown in FIG. 1, in accordance with an embodiment of the present invention. The method 42 is a method for using sCO₂ to cool a metallurgical processing furnace 12. As shown, the method 42 comprises using a reservoir 14 (see FIG. 1) to store the CO₂, using at least one of a compressor and a pump 16 (see FIG. 1) to pull the sCO₂ from the reservoir 14 and deliver the sCO₂ along cooling passages associated with the metallurgical processing furnace 12, using at least one of a pressure reducing valve and turbine 32 (i.e., a pressure reducing mechanism 30 as indicated in FIG. 1) to decrease the pressure of the sCO₂, and using a gas to air heat exchanger 36 (see FIG. 1) to cool the sCO₂ such that the sCO₂ is in a liquid state as the sCO₂ leaves the air to gas heat exchanger 36 and travels back to the reservoir 14. As shown, a chiller 40 (see FIG. 1) can also be used reduce the temperature of the sCO₂, into a liquid state before the sCO₂ proceeds to the reservoir 14.

Using sCO₂ as a coolant for metallurgical processing furnace 12 provides several advantages over using water, such as: (i) eliminating the need to keep the coolant below a certain temperature in order to preserve the integrity of cooling passages; (ii) eliminating the risk of explosions in case the coolant leaks through a crack or fusion into the furnace; (iii) providing for planned maintenance interventions without requiring the furnace itself to be suddenly halted for a long time, without affecting the productivity of the furnace; (iv) requiring fewer and less expensive maintenance and repair interventions with respect to those generally required by panels and cooling systems for metallurgical processing furnaces. Additionally, sCO₂ does not contain dissolved minerals like water does and therefore does not have an issue with inverse solubility fouling out the cooling passages. The sCO₂ cooling fluid can be operated at much higher temperatures than water, which reduces the heat loss from the furnace to the cooling fluid. Finally, the fact that sCO₂ has a lower viscosity compared to water allows for cooling passages to be smaller, which enables the thickness of the panels to be reduced thus reducing the costs of the panels.

While specific embodiments of the invention have been shown and described, it is envisioned that those skilled in the art may devise various modifications without departing from the spirit and scope of the present invention.

What is claimed is:

1. A waterless system for using sCO₂ to cool a metallurgical processing furnace, the system comprising:
a reservoir configured to store the sCO₂;
at least one of a compressor or a pump connected to the reservoir and configured to pull the sCO₂ from the reservoir and deliver the sCO₂ to cooling passages in one or more panels comprising the metallurgical processing furnace;
at least one of a pressure reducing valve or a turbine connected to the furnace and configured to decrease the pressure of the sCO₂; and
a gas to air heat exchanger connected to the reservoir as well as to the at least one pressure reducing valve or turbine, wherein the gas to air heat exchanger is configured to receive the sCO₂ from the at least one pressure reducing valve or turbine, and wherein the gas to air heat exchanger is configured to cool the sCO₂ such that the sCO₂ is in a liquid state as it leaves the air to gas heat exchanger and travels back to the reservoir.

2. The waterless system as recited in claim 1, wherein the at least one pressure reducing valve or turbine comprises the turbine, the turbine is coupled to a generator which recovers heat energy in the sCO₂ taken from the metallurgical processing furnace and turns the heat energy into electricity.

3. The waterless system as recited in claim 1, further comprising a chiller that is connected to the gas to air heat exchanger and the reservoir, wherein the chiller is configured to reduce the temperature of the sCO₂ and turn the sCO₂ into a liquid state before proceeding to the reservoir.

4. A method for using sCO₂ to cool a metallurgical processing furnace, the method comprising:
using a reservoir to store the sCO₂;
using at least one of a compressor or a pump connected to the reservoir to pull the sCO₂ from the reservoir and deliver the sCO₂ to cooling passages in one or more panels comprising the metallurgical processing furnace;
using at least one of a pressure reducing valve or a turbine connected to the furnace to decrease the pressure of the sCO₂; and
using a gas to air heat exchanger connected to the reservoir as well as to the at least one pressure reducing valve or turbine to receive the sCO₂ from the at least one pressure reducing valve or turbine and to cool the sCO₂ such that the sCO₂ is in a liquid state as the sCO₂ leaves the air to gas heat exchanger and travels back to the reservoir.

5. The method as recited in claim 4, wherein the step of using the at least one of a pressure reducing valve or a turbine comprises using the turbine which is coupled to a generator, and wherein the step further comprises using the generator to recover heat energy in the sCO₂ taken from the metallurgical processing furnace and turning the heat energy into electricity.

6. The method as recited in claim 4, further comprising using a chiller connected to the gas to air heat exchanger and the reservoir to reduce the temperature of the sCO₂ into a liquid state before the sCO₂ proceeds to the reservoir.
